(19) United States
(12) Patent Application Publication
(10) Pub. No.: US 2002/0099898 A1
(43) Pub. Date: Jul. 25, 2002

(54) Multifunction portable expansion card

(76) Inventor: David Oliphant, West Jordan, UT (US)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 09/765,940

(22) Filed: Jan. 19, 2001

(51) Int. Cl. G06F 13/12; G06F 13/38; G06F 13/36

(52) U.S. Cl. 710/306

(57) ABSTRACT

The present invention discloses a multifunction expansion card that facilitates the combination of communication card functionality with the ability to further incorporate a removeable extended device within the expansion card without requiring an additional expansion card slot within the host system. The expansion card of the present invention includes a communication card portion for coupling between the host system and the network. The expansion card also includes an extended device interface portion that provides the appropriate interfacing electronics for coupling the extended device to the host bus system. The expansion card includes a cutout area or slot for physically receiving therein the extended device for inclusion within the expansion card physical standard formfactor.

### BACKGROUND OF THE INVENTION

1. The Field of the Invention

The present invention relates generally to portable expansion cards. More particularly, the present invention relates to an improved multifunction portable expansion card for providing increased functionality for the host system.

2. The Prior State of the Art

Portable or down-sized computers have increased greatly in popularity due to the mobile-accommodating formfactor of such devices. In order to facilitate the mobility of such devices, portable computers traditionally assume a compact and intricately packaged grouping of electronics. To facilitate the expandability, extensibility, and customization of such computers, manufactures of such devices have made available expansion slots for receiving prepackaged custom electronics capable of interacting with the host or portable computer system. While various expansion slot formfactors may be assumed or adapted, the industry has recognized the benefits of providing a standardized interface. To this end, several manufactures collaborated to form the Personal Computer Memory Card International Association (PCMCIA). This body developed and promulgated standards for the physical design, dimensions, and electrical interface of expansion devices. Specifically, the PCMCIA PC card standard identifies three primary card types or dimensions: Type I, Type II, and Type III. These PC card types correspond to physical dimension restrictions of 85.6 mm (length)×54.0 mm (width). Type I PC cards have a further dimensional restriction regarding thickness of 3.3 mm. Type II PC cards allow device thicknesses of up to 5.0 mm., while Type III PC cards allow for thicknesses of 10.5 mm. Presently, many computers being manufactured, especially those of a portable nature, are adapted to accommodate or provide expansion slots in accordance with the standards.

One particular common configuration of these PCMCIA expansion slots is to provide for two Type II expansion slots stacked one upon the other which allows for the insertion of two individual Type II PCMCIA expansion devices or PC cards or, alternatively, the insertion of a single Type III expansion device or PC card. While the original functionality of expansion PCMCIA cards facilitated the expansion of available host memory, one predominate application for PCMCIA cards has been to integrate communication circuitry in the form of network interface cards for dial-up finctionality, as in the case of modem circuitry, into the self-contained confines of a PC card. Integration of such functionality into a removable expansion card facilitates upgrading the communication capability as technology advancements become available.

Since communication cards are one of the dominate applications for PCMCIA expansion cards, it is necessary to provide a connector interface on those cards for coupling with the communication network. The predominate connecting standard is to interface with industry standard connectors in the form of RJ-11 and RJ-45 cables. While the electronics required to facilitate a network and a modem interface have become sufficiently integrated to allow the requisite circuitry to be placed within the confines of a Type II expansion card, those of skill in the art appreciate the relatively large dimensions associated with the RJ cable plugs. Therefore, in order to accommodate direct coupling of such ubiquitous connectors to the communication cards, the communication cards exhibit a Type III thickness for directly receiving and housing an RJ modular jack.

When communication cards assume the larger Type III configuration, all of the expansion slots in a traditional two-Type II stacked expansion slot configuration are then occupied by the communication card thereby foreclosing other devices from communicating with the host system via the expansion slot environment. Other expansion devices that have recently come into common usage include transportable memory devices, such as those used for storing image information from portable cameras and computers because of the digital nature of such images, it is desirable to transfer image information from a camera using this transportable memory configuration to a computer environment for manipulation, storage, viewing, or other processing including printing. Manufactures of such portable memory devices have viewed the PCMCIA expansion slot as an interface through which information on the portable memory devices may be exchanged with the computing environment. In order to accommodate the physical, and any electrical incompatibilities between the portable memory device and the PCMCIA expansion slot, manufactures have developed adapters for coupling portable memory devices such as compact flash, smart media, and other accepted standards directly into the PCMCIA expansion slot.

Users of such extended or portable memory adapters have become frustrated with the need to keep track of such adapter devices and further frustrated when such adapters cannot coexist within the limited quantity of expansion slots when a communication card is present therein and occupies all expansion slot locations. Therefore, there is a need to provide a system for facilitating the coexistence of a communication card and other expandable devices such as portable memory devices without requiring an expansion of the available number of expansion slots nor requiring the user to swap or select between housing and communication capability or other expandability devices within the limited expansion slot capability of a mobile or down-sized computing environment.

### SUMMARY OF THE INVENTION

A multifunction expansion card is presented which facilitates the integration of both communication functionality and an extended device adaptor into a single footprint capable of simultaneous interface with a host computer bus for interfacing in a limited-number of adapter-slot type environment. Such multifunction expansion card enables an effective enlargement of the number of devices that may actually interact with the host system even though the number of available slots is exceeded by the present number and sizes of devices.

The expansion card includes a housing that is compatible with the available slot volume within the receptor slot of the host system. The housing is further comprised of a cutout region or area which allows for the insertion of the extended device within the general confines of the defined volume for the housing. Various accommodations for placement and position of the cutout region are described and are primarily a function of the dimensions of the desired extended device.

The expansion card is comprised of a communication card portion for facilitating interaction between a host system of the multifunction expansion card and a communication network. Exemplary types of communication card portion functionality include local area network (LAN) functionality and/or modem/wide area network (WAN) functionality. Such functionality has traditionally been relegated to interface devices or cards generally known as communication cards and may further include additional functionality such as cellular interfaces or the like.

The expansion card is further comprised of an extended device interface portion independent of the communication card portion for facilitating interaction between the host system of the multifunction expansion card and the removable extended device. Exemplary removable extended devices include extendable/removable memory or other functionality generally assuming a removable formfactor which has heretofore involved interfacing the removable extendable device with an adaptor assembly for compatible interfacing with a slot or port of a host system.

The expansion card may assume a formfactor consistent with one of various defined card standards. One such acceptable standard is the PCMCIA standard with defines both a physical dimension standard and an electrical interface standard. This particular standard further distinguishes between separate sizes of cards within the standard, for example, Type I, Type II and Type III cards having increasing height specifications.

As electronics have become increasingly more integrated and as host systems have also become more standardized, many host systems have resigned themselves to certain slot configurations. In most host systems, the primary slot configuration is often two separate Type II slots or a single Type III slot arrangement. Additionally, since communication cards interface with networks via communication cables, and since these cables almost exclusively employ RJ-type connectors having height dimensions in excess of the smaller Type II configuration, a Type III formfactor is either necessary or preferred. Since this single communication device would then occupy the entire available slot arrangement within the traditional host system, the simultaneous use of another device such as an extended device needing a PCMCIA adapter would be an impossibility without the teachings of the present invention.

Therefore, the present invention provides a single expansion card having both the communication card portion and the extended device portion electronics within the housing of the expansion card. The housing further comprises a cutout area for receiving within the general confines of the defined housing dimension, the removable extended device.

Additional advantages of the invention will be set forth in the description which follows, and in part will be obvious from the description, or may be learned by the practice of the invention. The objects and advantages of the invention may be realized and obtained by means of the instruments and combinations particularly pointed out in the appended claims. These and other objects and features of the present invention will become more fully apparent from the following description and appended claims, or may be learned by the practice of the invention as set forth hereinafter.

### BRIEF DESCRIPTION OF THE DRAWINGS

In order that the manner in which the above recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary system that provides a suitable operating environment for the present invention;

FIG. 2 is a block diagram of the functional components of an expansion card, in accordance with a preferred embodiment of the present invention;

FIG. 3 is a perspective view of one mechanical configuration for receiving a generally planar extended device in a first orientation in accordance with a preferred embodiment of the present invention;

FIG. 4 is a perspective view of another mechanical configuration for receiving a generally planar extended device in a second orientation in accordance with a preferred embodiment of the present invention;

FIG. 5 is a perspective view of another mechanical configuration for receiving a generally planar extended device in a third orientation in accordance with a preferred embodiment of the present invention;

FIG. 6 is a perspective view of another mechanical configuration for receiving an elongated extended device in accordance with a preferred embodiment of the present invention; and

FIG. 7 is a perspective view of another mechanical configuration for slideably receiving therein an extended device in accordance with a preferred embodiment of the present invention.

### DETAILED DESCRIPTION OF THE PREFERRED EMBODIMENTS

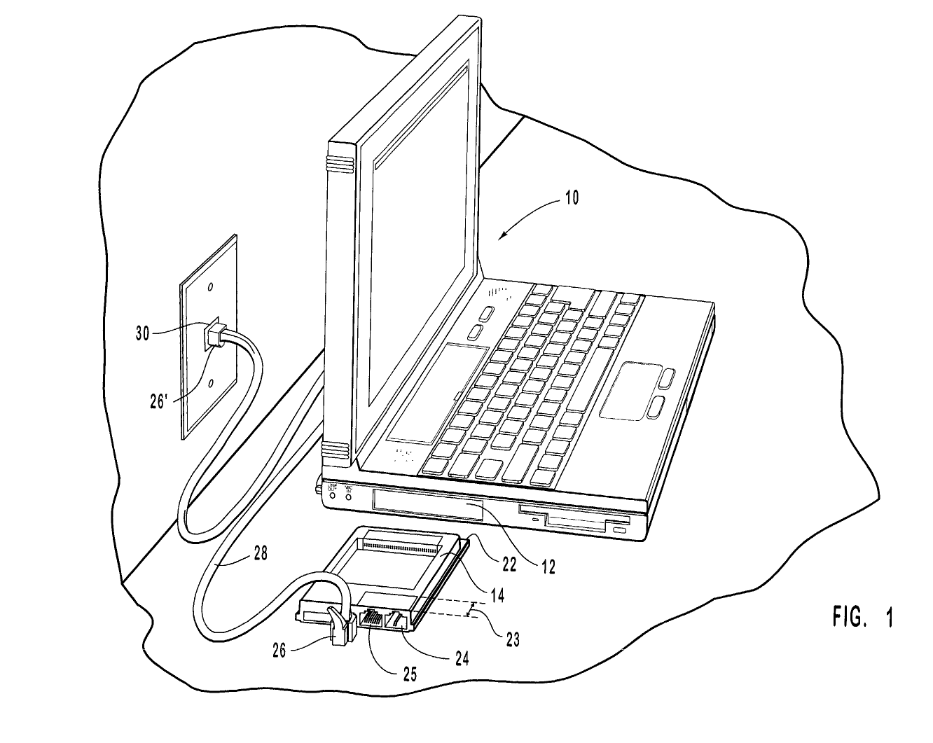

Reference is first made to FIG. 1, an exemplary system or environment in which the present invention may be utilized or implemented. FIG. 1 is intended to be illustrative of potential systems that may utilize the present invention and is not to be construed as limiting. The system of FIG. 1 illustrates a portable computer 10 having portable expansion slots 12 that are configured to receive miniature portable expansion card 14 therein.

Exemplary portable expansion configurations that are contemplated within the present invention which incorporate a portable expansion card 14 and portable expansion slots 12 include PCMCIA configurations, ATA (Advanced Technology Attachment) configurations, or other miniature expansion card configurations wherein an expansion card interfaces with a form of bus structure within an expansion slot and facilitates the additional interaction with a removable extended device housed within the volume of portable expansion card 14. The present invention contemplates expansion configurations wherein the available quantity of expansion slots is exceeded by the number of expansion cards preferably desired to be received within the portable computer arrangement or configurations wherein separate adapter devices are unnecessary due to the available coupling of the extended device with the host system via the multifunction expansion card of the present invention.

Portable expansion card 14 interfaces with a communication network through one or more interfaces which are exemplarily depicted in FIG. 1. These communication interfaces include a connector socket or jack 24 and it may alternatively include additional connector sockets or jacks depicted as connector jack 25. By way of example, and not limitation, connector jack 24 is depicted as an RJ-11 interface for providing the external coupling, via a media cable 28 having thereon connector plug 26 and 26′ for facilitating the connection between the modem functionality within portable expansion card 14 and, for example, a telephone network depicted with an interface such as a jack 30. Similarly, connector jack 25 may assume an RJ-45 configuration for facilitating coupling of network functionality resident within portable expansion card 14 with a network such as a local area network.

It should be appreciated that the communication circuitry for performing modem and network functionality have been sufficiently integrated so as to fit within, for example, the volume specifications of a PCMCIA Type II configuration. However, the traditional and dominant connector interfaces for coupling to such communication functionalities have retained connector standards, such as the RJ-11 and RJ-45 connector interfaces which maintain dimensions of a height which is greater than the height of a Type II PCMCIA card. Therefore, the portable expansion card profile assumes this, otherwise unnecessarily tall profile. This excess profile facilitates the inclusion of a removable extended device therein.

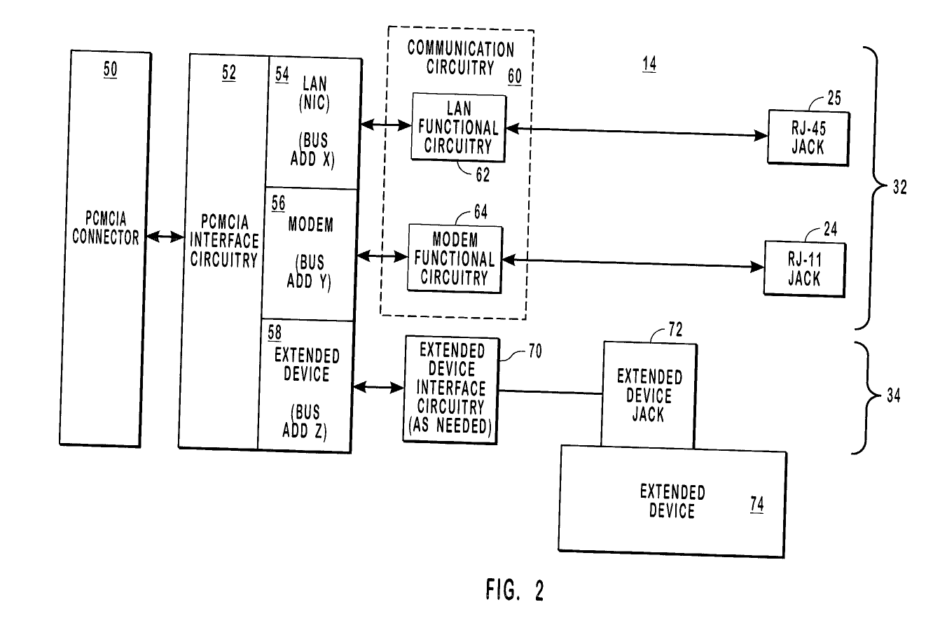

FIG. 2 depicts a block diagram of the various functional and structural components of the portable expansion card, in accordance with a preferred embodiment of the present invention. Portable expansion card 14 is comprised generally of a first communication card portion 32 for facilitating interaction between a host system, such as portable computer 10 (FIG. 1), and a communication network, and a second extended device interface portion 34 which is independent of communication card portion 32.

Extended device interface portion 34 facilitates interaction between the host system and a removable extended device, depicted as extended device 74. While communication card portion 32 is independent from extended device interface portion 34, both portions reside within a common housing or footprint and preferably share a singular physical interface with the host system, although the interfaces could also be divided. The common system interface with the host system is depicted, by way of example, as PCMCIA connector 50. It should be reiterated, however, that various interface standards may be employed and are contemplated within the scope of the present invention. The physical interface, depicted as PCMCIA connector 50, further couples with a functional or electrical component depicted as PCMCIA interface circuitry 52. PCMCIA interface circuitry 52 is depicted as being comprised of independent components, which when implemented may share common processing resources. The communication card portion of PCMCIA interface circuitry 52 is comprised of one or more interface components, such as a network interface 54 and/or a modem interface 56. Those of skill in the art appreciate that such interface circuitry components may take the form of uniquely addressable interfaces. Communication card portion 32 is further comprised of communication circuitry 60 which is comprised of the respective functional circuitry 62 and 64. Such functional circuitry is appreciated by those of skill in the art to include data pumps including signal processors, CODEC, DAA, off-hook and ring-detect circuitry, to name but a few. Communication card portion 32 is further comprised of the physical interfaces for interfacing with the respective communication networks, depicted herein as connector jacks 24 and 25.

Extended device interface portion 34 for facilitating interaction between the host system and removable extended device 74, is comprised of a portion of PCMCIA interface circuitry 52 depicted as extended device circuitry 58 which provides a uniquely addressable interface to the PCMCIA bus. Extended device interface portion 34 is further comprised of extended device interface circuitry 70, when not integrated within extended device 74, which provides any necessary buffering or timing conversion circuitry for further facilitating the interaction between the host system and extended device 74. Extended device interface portion 34 is further comprised of a physical extended device jack 72 for removably engaging with extended device 74.

Extended device 74 may be comprised of a myriad of removable devices including, but not limited to, removable extended memory devices providing extended storage to the host system by way of an extended memory interface, such as extended device interface circuitry 70. Those of skill in the art appreciate that various physical forms of extended device 74 assuming a removable extended memory configuration include CompactFlash™, SmartMedia™, Memory Stick® as well as other forms of removable storage media. It is preferred that extended device 74, in its myriad of embodiments, assumes a profile and dimensions which facilitate its physical placement and retention within the general volume boundaries of portable expansion card 14. Such inclusion of extended device 74 within the general confines of the voluminous portable expansion card 14, due to the unnecessarily large connector configuration, facilitates the merging of an otherwise traditional communications card having a low profile with an adaptor card necessary for conforming extended device 74 into a form factor compatible with interfacing into portable expansion slots 12. It should be further appreciated that while it is most desirable that extended device 74 be retained within the volume restrictions of portable expansion card 14, if extended device 74 is configured so as to extend outside an exposed facet of portable expansion card 14, such as an external interface end, the spirit of integration has been achieved and is contemplated to be within the scope of the present invention.

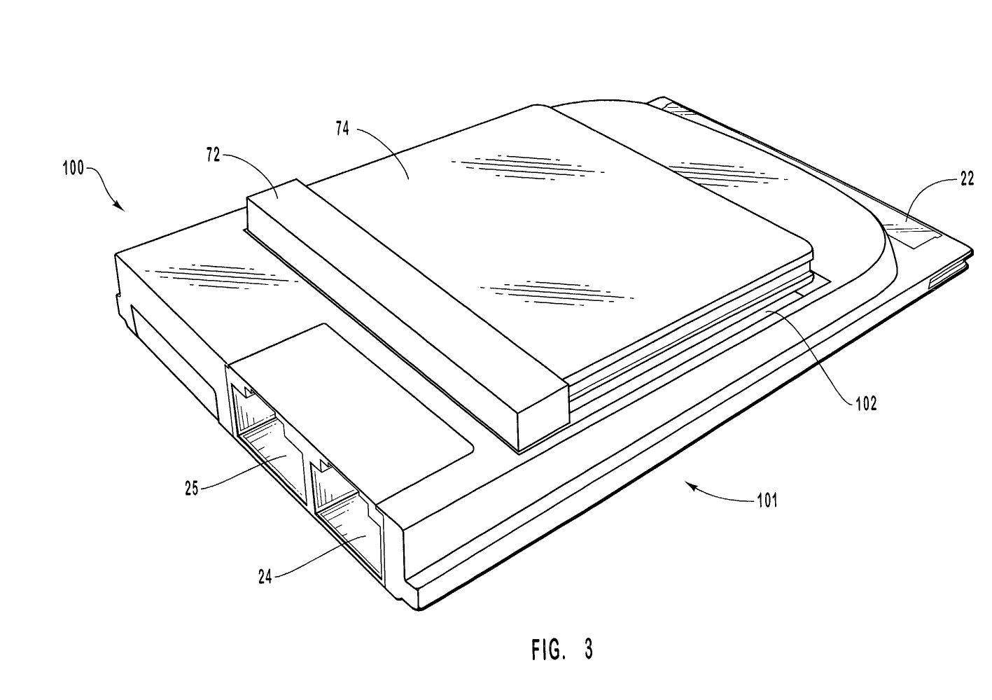

FIG. 3 depicts a perspective view of a portable expansion card, in accordance with a preferred embodiment of the present invention. FIG. 3 depicts one embodiment of portable expansion card 100 assuming a PCMCIA form factor. As such, portable expansion card 100 is comprised of a PCMCIA connector 22 for interfacing with the host system supporting a PCMCIA interface. Portable expansion card 100 is further comprised of a housing 101 forming boundaries for compatible insertion within the PCMCIA expansion slot. In the present depicted embodiment, housing 101 assumes a type III form factor and includes therein the PCMCIA interface circuitry coupled to the PCMCIA connector for providing electrical compatibility with the PCMCIA interface of the host system. Additionally, the communication circuitry, extended device interface circuitry and associated extended device jack are all resident within the confines of housing 101.

Housing 101 is further shaped to include a cutout 102 for physically receiving the corresponding formfactor of the extended device 74. In FIG. 3, extended device 74 is depicted as a CompactFlash™ extended memory card having a generally planar profile. For operably interfacing extended device 74 with portable expansion card 100, extended device 74 is inserted into cutout 102 and manipulated into alignment with extended device jack 72 for electrical and mechanical mating with portable expansion card 100. When fully inserted into cutout 102 and operably mated with extended device jack 72, extended device 74 is compatibly within the confines of the volume defined by the corresponding specification, such as exemplary shown as a Type III PCMCIA card.

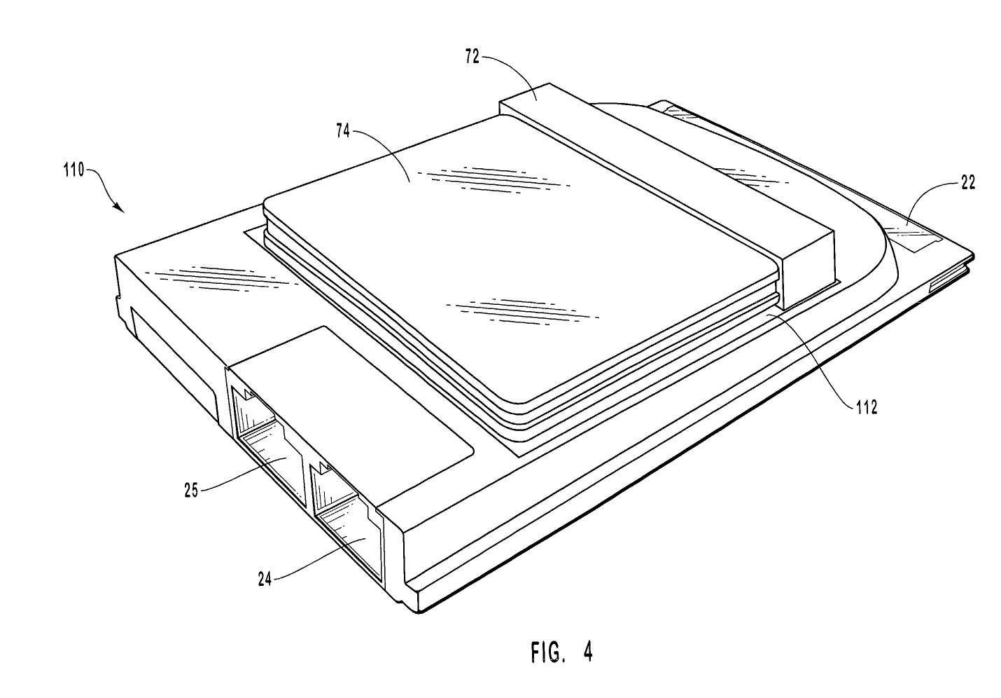

FIG. 3 depicts extended device jack 72 as being located backed against connector jack 24 thereby allowing a common high profile backbone. However, in FIG. 4, extended device 74 is depicted as oriented in an opposite direction with extended device jack 72 being fixedly mounted near PCMCIA connector 22. It should be appreciated that what is preferred in either the orientation of FIGS. 3 and 4 is that there exists adequate travel within cutout 102 for the insertion and removal of extended device 74.

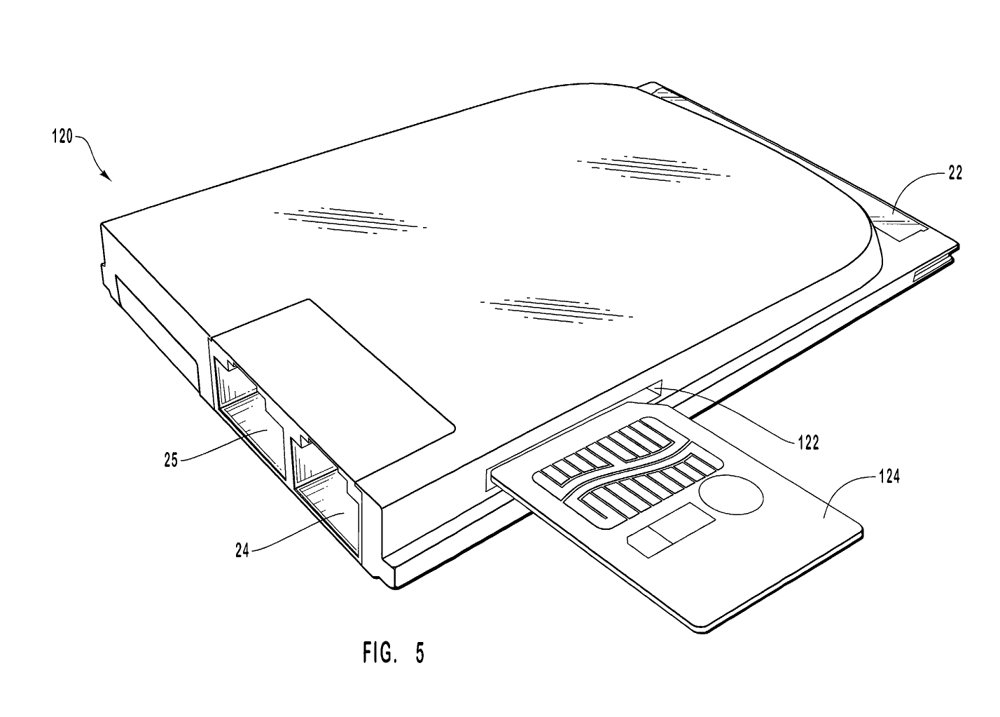

FIG. 5 depicts a portable expansion card for receiving therein an extended device, in accordance with another embodiment of the present invention. Portable expansion card 120 is depicted having a housing for receiving into a slot cutout 122 the extended device 124 when the dimensions of extended device 124 are sufficiently compact to be received therein. In FIG. 5, extended device 124 is depicted as extendable memory having an exemplary formfactor in accordance with the specifications of a SmartMedia™ extended memory device. While FIG. 5 depicts portable expansion card 120 as receiving extended device 124 into a slot cutout on a side portion, extended device 124 may also be placed on any other facets of portable expansion card 120 where it does not affect the profile of connectors or otherwise impair performance.

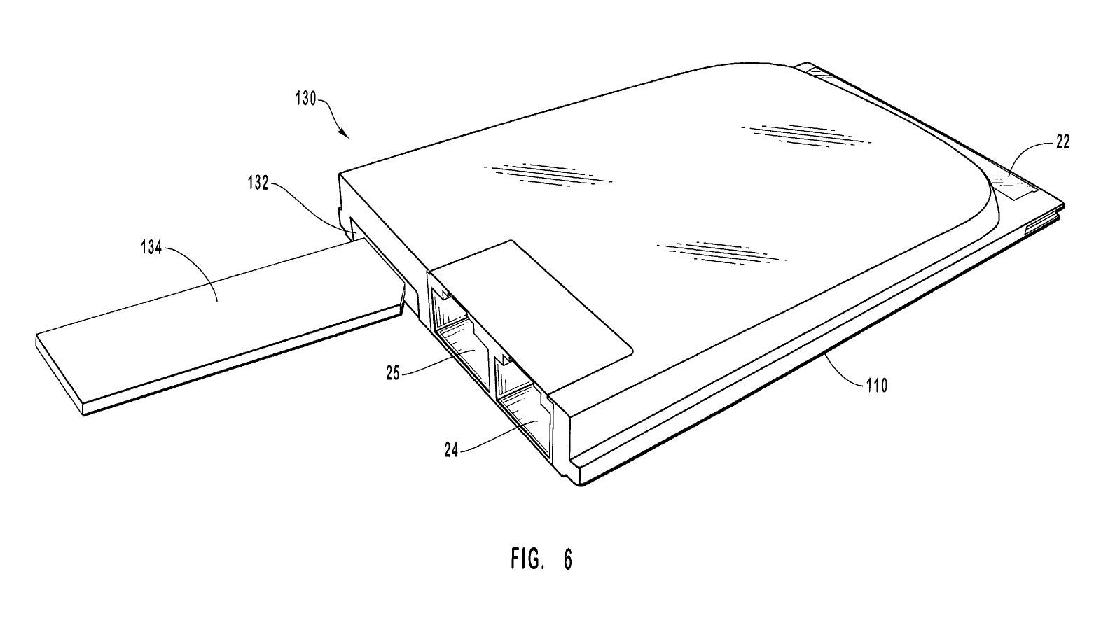

FIG. 6 depicts a portable expansion card for receiving an extended device therein, in accordance with another embodiment of the present invention. For extended devices having a more linear and less planar profile, a cutout 132 may be placed on an open facet of housing 110 that facilitates the insertion and removal of an extended device without the removal of portable expansion card 130. In FIG. 6, an extended device having such a profile is depicted as extended device 134 and may assume a common configuration such as the Memory Stick® manufactured by Sony Corporation. It should also be appreciated from FIG. 6 that if the facet of housing 110 is not fully populated with connectors 24, 25, then extended devices having an additional planar dimension may be accommodated by the open facet insertion technique of the present embodiment.

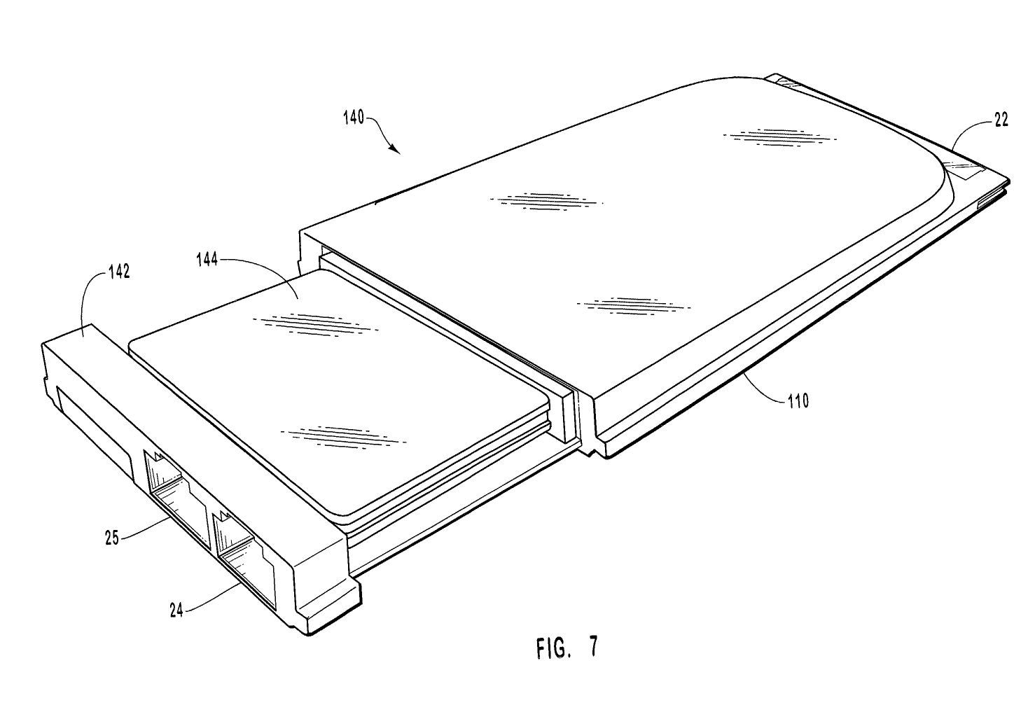

FIG. 7 depicts another embodiment of a portable expansion device for receiving an extended device therein, in accordance with another embodiment of the present invention. In this figure, the open facet is comprised of a tray that extends from the general housing of portable expansion device 140 for receiving extended device 144 when tray 142 is in an extended position. Such a configuration, like that depicted in FIG. 6, also facilitates the insertion and removal of extended device 144 without removing portable expansion device 140 from the receiving slot.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. A multifunction expansion card comprising:
a) a communication card portion for facilitating interaction between a host system of said multifunction expansion card and a communication network; and
b) an extended device interface portion independent of said communication card portion for facilitating interaction between said host system of said multifunction expansion card and a removable extended device capable of substantially residing within an expansion card volume allocated to said multifunction expansion card.

2. The multifunction expansion card, as recited in claim 1, wherein said extended device interface portion provides both an electrical interface and a physical interface for said removable extended device substantially within said expansion card volume.

3. The multifunction expansion card, as recited in claim 2, wherein said expansion card and said expansion card volume complies with the PCMCIA standard.

4. The multifunction expansion card, as recite in claim 3, wherein said expansion card further complies with a Type III form-factor of said PCMCIA standard.

5. The multifunction expansion card, as recited in claim 1, wherein said communication card portion functions as a network interface card for providing interaction between said host system and communication network.

6. The multifunction expansion card, as recited in claim 1, wherein said communication card portion functions as a modem card for providing interaction between said host system and communication network.

7. The multifunction expansion card, as recited in claim 1, wherein said extended device interface portion is an extended memory interface and said removable extended device is an removable extended memory device, said extended memory interface facilitating interaction between said host system and said removable extended memory device.

8. The multifunction expansion card, as recited in claim 7, wherein said extended memory interface is compatible with a memory card having a compact flash configuration.

9. The multifunction expansion card, as recited in claim 7, wherein said extended memory interface is compatible with a memory card having a smart media configuration.

10. The multifuiction expansion card, as recited in claim 7, wherein said extended memory interface is compatible with a memory card having a memory stick configuration.

11. A Type III PCMCIA expansion card for providing both communication card functionality and for supporting a removable extended device therein, said expansion card comprising:
a) interface circuitry for operably coupling said expansion card with a host system supporting a PCMCIA expansion slot;
b) communication circuitry for compatibly coupling said host system, via said interface circuitry, with a communication network;
c) extended device interface circuitry for operably coupling with said interface circuitry and providing an operable interface with said removable extended device.

12. The Type III PCMCIA expansion card, as recited in claim 11, wherein said extended device interface is an extended memory interface and said removable extended device is an removable extended memory device, said extended memory interface facilitating interaction, via said interface circuitry, between said host system and said removable extended memory device.

13. The Type III PCMCIA expansion card, as recited in claim 12, wherein said extended memory interface is compatible with a memory card having a compact flash configuration.

14. The Type III PCMCIA expansion card, as recited in claim 12, wherein said extended memory interface is compatible with a memory card having a smart media configuration.

15. The Type III PCMCIA expansion card, as recited in claim 12, wherein said extended memory interface is compatible with a memory card having a memory stick configuration.

16. A PCMCIA expansion card, comprising:
a) a PCMCIA connector for interfacing with a host system supporting a PCMCIA interface;
b) a housing forming boundaries of said PCMCIA expansion card, including therein,
i) PCMCIA interface circuitry coupled to said PCMCIA connector for providing electrical compatibility with said PCMCIA interface of said host system;
ii) communication circuitry for compatibly coupling said host system, via said PCMCIA interface circuitry, with a communication network;
iii) extended device interface circuitry for operably coupling with said PCMCIA interface circuitry and providing an operable interface with said removable extended device; and
said housing further including a cutout region for receiving said removable extended device substantially therein for operable coupling with said extended device interface circuitry.

17. The PCMCIA expansion card, as recited in claim 16, wherein said communication circuitry functions as a network interface card for providing interaction between said host system and communication network.

18. The PCMCIA expansion card, as recited in claim 16, wherein said communication circuitry functions as a modem card for providing interaction between said host system and communication network.

19. The PCMCIA expansion card, as recited in claim 16, wherein said extended device interface circuitry is an extended memory interface and said removable extended device is an removable extended memory device, said extended memory interface facilitating interaction between said host system and said removable extended memory device.

20. The PCMCIA expansion card, as recite in claim 16, wherein said PCMCIA expansion card further complies with a Type III form-factor.
